(19) United States
(12) Patent Application Publication
(10) Pub. No.: US 2014/0169252 A1
(43) Pub. Date: Jun. 19, 2014

(54) SENSOR NODE LOCATION-BASED POWER OPTIMIZATION

(71) Applicants: Neel Banerjee, Corvallis, OR (US); George H. Corrigan, Corvallis, OR (US); Andrew L. Van Brocklin, Corvallis, OR (US); Anton N. Clarkson, Corvallis, OR (US); David A. Champion, Lebanon, OR (US)

(72) Inventors: Neel Banerjee, Corvallis, OR (US); George H. Corrigan, Corvallis, OR (US); Andrew L. Van Brocklin, Corvallis, OR (US); Anton N. Clarkson, Corvallis, OR (US); David A. Champion, Lebanon, OR (US)

(21) Appl. No.: 14/235,730

(22) PCT Filed: Jul. 29, 2011
(86) PCT No.: PCT/US2011/045847

§ 371 Date: Jan. 28, 2014

(51) Int. Cl. H04W 52/02; H04W 4/02

(52) U.S. Cl. CPC H04W 52/0225; H04W 4/023
USPC 370/311

(57) ABSTRACT

Sensor node location-based power consumption optimization employs an adjustable minimum detectable signal (MDS) level that is set based on a location of a sensor node relative to a location of a source of an event signal. The sensor node includes a sensor to respond to the event signal and an interface module to determine the sensor response to the event signal. The interface module has the adjustable MDS level and a power consumption that is a function of the adjustable MDS level. The adjustable MDS level is set to optimize power consumption.

### CROSS-REFERENCE TO RELATED APPLICATIONS

N/A

### STATEMENT REGARDING FEDERALLY SPONSORED RESEARCH OR DEVELOPMENT

N/A

### BACKGROUND

Sensors of various kinds including, but not limited to, accelerometers of various designs and configurations, velocity sensors, and geophones as well as other related acoustic transducers, are used in a wide variety of applications ranging from exploration to intrusion detection and perimeter defense. For example, an array of seismic sensors (e.g., geophones or accelerometers) that sense vibrations in the soil and subsurface layers of the earth may be deployed over a field in support of subsurface exploration activities. Similar seismic sensor arrays are routinely used to monitor naturally occurring seismic waves due to one or more of volcanic activity, tectonic movements (e.g., earthquakes), and other natural processes. In another example, the motion of bridges and other structures, either due to normal operation of the structure or induced on or within the structure by outside forces, may be monitored and even controlled using inputs from an array of vibration sensors. Moreover, sensors deployed within a defensive perimeter or along a border may facilitate the detection of intruders as well as monitoring other activities associated with the perimeter or border, for example.

Often the number of sensors or sensor nodes that are used in a given application may become large or even very large (e.g., 100 to 1000 or more vibration sensors per array). In addition, a speed at which sensors are or may be deployed is often an important factor in certain applications (e.g., in battle field defense or large scale exploration applications). Especially with large or very large arrays and when deployment speed and deployed lifetime is a factor, consideration of power consumption by the sensor nodes as well as a sensor system as a whole may be an important consideration in system design. While both dynamic power management (DPM) and dynamic voltage scaling (DVS) have been employed, these techniques alone may not be enough to fully optimize power consumption of a sensor system.

### BRIEF DESCRIPTION OF THE DRAWINGS

Various features of examples in accordance with the principles described herein may be more readily understood with reference to the following detailed description taken in conjunction with the accompanying drawings, where like reference numerals designate like structural elements, and in which:

FIG. 1 illustrates a schematic block diagram of a sensor node, according to an example of the principles described herein.

FIG. 2 illustrates a schematic diagram of a portion of a sensor node, according to an example of the principles described herein.

FIG. 3 illustrates a block diagram of a sensor system, according to an example of the principles described herein.

FIG. 4 illustrates a flow chart of a method of location-based power consumption optimization of a sensor system, according to an example of the principles described herein.

Certain examples have other features that are one of in addition to and in lieu of the features illustrated in the above-referenced figures. These and other features are detailed below with reference to the above-referenced figures.

### DETAILED DESCRIPTION

Examples in accordance with the principles described herein provide location-based power consumption optimization for sensor nodes, and for sensor systems in which the sensor nodes are employed. In particular, power consumption of individual sensor nodes may be optimized based on a location of the individual sensor nodes relative to a location of an event source that produces an event signal being sensed or monitored, according to various examples. For example, location-based power optimization may result in a reduction and, in some examples, a minimization of power consumed by the sensor nodes. By extension, location-based power consumption optimization at the sensor node level similarly may optimize power consumption of the entire sensor system that uses the sensor nodes, in some examples. Power consumption of individual sensor nodes within the system may be set or adjusted dynamically using the information associated with the relative location(s) of the sensor nodes and event source. The location-based power consumption optimization described herein has application in a wide variety of sensor nodes and sensor systems applications including, but not limited to, seismic exploration using an array of hundreds or even thousands of sensor nodes (e.g., accelerometers).

For example, sensor systems that include large and very large numbers of sensor nodes (e.g., greater than or much greater than 100 sensor nodes) may realize particular benefit from the location-based power consumption optimization both at a system wide level as well as with respect to individual sensors themselves. In particular, system wide power consumption can drive both system costs and system availability. Location-base power consumption optimization may provide a means for controlling system-wide costs as well as system availability, for example. Similarly, a lifetime of individual sensor nodes (e.g., in the field) as well as a cost and overall physical size of the sensor nodes are often driven by expected average and peak power consumption levels. Location-based power consumption optimization may facilitate realizing sensor nodes that exhibit one or more of lower production costs, longer deployment lifetimes and smaller overall size and weight, for example.

According to various examples, location-based power consumption optimization may be provided by selectively adjusting a minimum detectable signal (MDS) level of sensor nodes based on the location of the various sensor nodes relative to a location of the event source. In particular, power consumption of components within the sensor node as well as the sensor node as a whole may be a function of the MDS level. In some examples, the power consumption is an inverse function of the MDS level. Examples in accordance with the principles described herein take advantage of this relationship to optimize (e.g., minimize) power consumption of both individual sensor nodes and a sensor system that employs them.

For example, sensor nodes that are located closer to the event source where the event signal is generally stronger may employ a high MDS level. Sensor nodes located further away from the event source where the event signal is generally much weaker may employ a relatively lower MDS level to facilitate detection and processing of the weaker event signal. The MDS level is inversely related to power consumption, as such the sensor nodes closer to the event source and having the higher MDS level may consume less power than the sensor nodes located farther away from the event source. As a result, power consumption of individual sensor nodes may be optimized by adjusting the MDS level of the sensor node, based on relative location, to be ‘just good enough’ to capture and process the event signal level expected at a given relative location of the individual sensor nodes. Adjusting the MDS level to be ‘just good enough’ may reduce, and in some instances, minimize (i.e., optimize) power consumption of a plurality of such sensor nodes, for example.

According to some examples, sensor nodes may employ capacitive sensors. Capacitive sensors are often realized as dynamic sensors that are driven by a carrier signal to sense changes in a physical quantity (e.g., acceleration, vibration, pressure, etc.) in terms of a change in capacitance associated with that physical quantity. In a sensor node that uses a dynamic capacitive sensor, one or more of carrier frequency, drive voltage and sense amplifier bias may be employed to set a noise floor (i.e., sensitivity) and in turn, to adjust the MDS level of the sensor node. Furthermore, power consumption is typically proportional to each of carrier frequency, drive voltage and sense amplifier bias. As such, decreasing and increasing the MDS level using changes in carrier frequency, drive voltage and sense amplifier bias may produce an inversely concomitant increase and decrease in sensor node power consumption, for example. Given information about the relative locations of the sensor nodes and the event source along with the expected event signal level as a function of the locations, the MDS level may be adjusted accordingly by adjusting one or more of carrier frequency, drive voltage and sense amplifier bias, for example.

As used herein, the article ‘a’ is intended to have its ordinary meaning in the patent arts, namely ‘one or more’. For example, ‘a sensor’ means one or more sensors and as such, ‘the sensor’ means ‘the sensor(s)’ herein. Also, any reference herein to ‘top’, ‘bottom’, ‘upper’, ‘lower’, ‘up’, ‘down’, ‘front’, back’, ‘left’ or ‘right’ is not intended to be a limitation herein. Herein, the term ‘about’ when applied to a value generally means within the tolerance range of the equipment used to produce the value, or in some examples, plus or minus 10%, or plus or minus 5%, or plus or minus 1%, or unless otherwise expressly specified. Moreover, examples herein are intended to be illustrative only and are presented for discussion purposes and not by way of limitation.

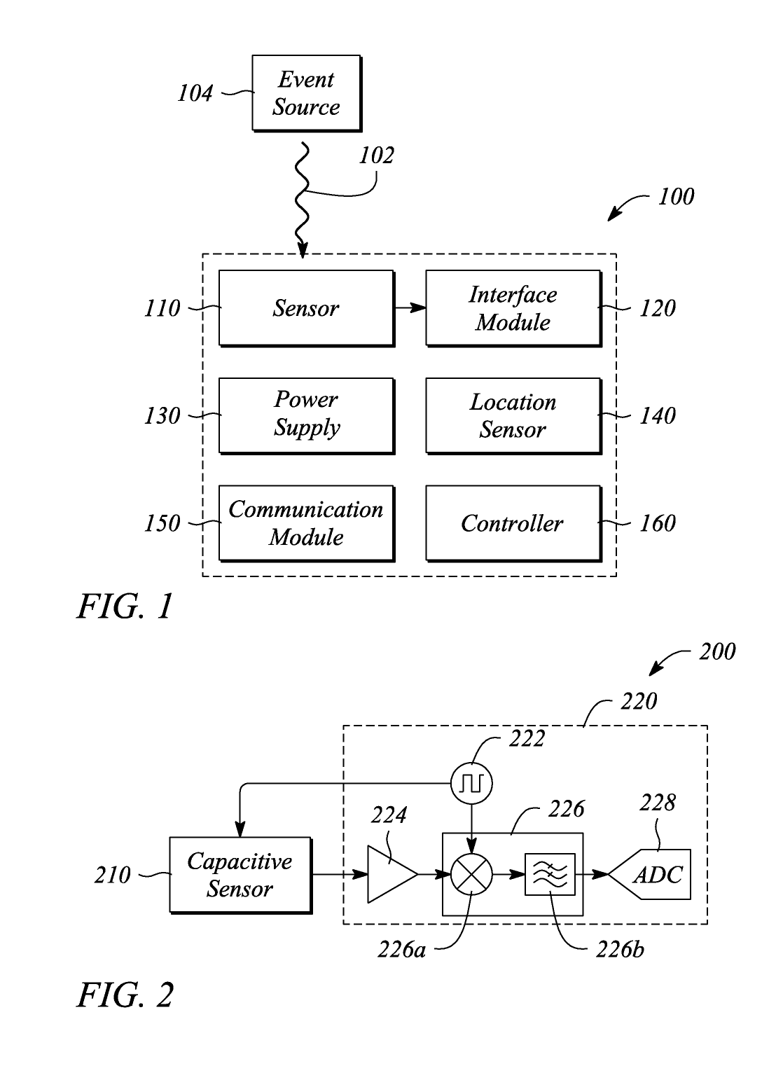

FIG. 1 illustrates a schematic block diagram of a sensor node 100, according to an example of the principles described herein. The sensor node 100 senses an event signal 102 produced by an event source 104 and provides location-based power consumption optimization, according to various examples. In particular, the sensor node 100 may provide one or both of detection and measurement, or a related processing of the event signal 102 produced by the event source 104. Further, a location of the sensor node 100 relative to a location of the event source 104 is either a priori known or may be determined.

In some examples, the relative location is determined in terms of a relative distance or radial distance. A ‘relative distance’ or a ‘radial distance’ is defined as a distance between two objects that does not take into account a direction. For example, the relative location in terms of a radial distance between the sensor node 100 and the event source 104 may be determined by measuring a ‘straight-line’ distance between the sensor node 100 and the event source 104. The straight-line distance is a distance along a line extending radially from the sensor node 100 to the event source, for example. Alternatively, a location with respect to a coordinate system (e.g., latitude and longitude) may be known for the sensor node 100 and the event source 104 such that the relative distance may be readily computed or otherwise determined.

In some examples, both of a location of the sensor node 100 and a location of the event source 104 are fixed. For example, the sensor node 100 may be placed or installed at a predetermined and substantially unchanging location. Similarly, the location of the event source 104 may be predetermined and fixed according to a particular installation, for example. As such, the location of the sensor node 100 relative to the event source 104 (i.e., the relative location) is also fixed. In other examples, one or both of the sensor node and the event source 104 are mobile. In these examples, the relative location of the sensor node 100 and the event source 104 may vary with time. However, even when one or both of the sensor node 100 and the event source 104 are mobile, the relative location of the event source 104 and the sensor node 100 is always known a priori or may be readily determined at a point in time when the sensor node 100 is sensing the event signal 102 from the event source 104, according to the principles described herein.

For example, when both of the event source 104 and the sensor node 100 are mobile, the locations of both the mobile event source 104 and the mobile sensor node 100 may be measured just prior to production of the event signal 102 by the event source 104 and the relative location determined from the measured locations. In another example, the relative distance may be measured directly. In yet another example, the relative location may be inferred from dynamic information about the system. For example, dynamic information associated with planned paths of the mobile event source 104 and the mobile sensor node 100 may be employed to infer or deduce respective locations therein at a time corresponding to arrival of the event signal 102.

In another example, the sensor node 100 has a predetermined and fixed location while the event source 104 is mobile. In this example, the location of the event source 104 is measured or otherwise determined to establish the relative location. In yet another example, the sensor node 100 is mobile and the event source 104 is fixed. In this example, only the location of the mobile sensor node 100 just prior to the arrival of the event signal 102 is measured or otherwise determined. In some examples, the radial distance between the sensor node 100 and event source 104 is monitored dynamically and, in some examples, substantially constantly as a function of time. Hence, when the event source 104 produces the event signal 102, the radial distance (i.e., the relative location) is known a priori.

In some examples, the relative location of the sensor node 100 and the event source 104 is provided by a global position system (GPS). For example, one or both of the sensor node 100 and the event source 104 may be equipped with GPS receivers to measure and determine their respective locations. In other examples, the location(s) are determined by another means including, but not limited to, various surveying and triangulation methodologies, interferometry and various location-determining methods based on photography. In yet other examples, the sensor node 100 may monitor a strength of a signal emanating from the event source 104. The radial distance from the event source 104 to the sensor node 100 may be inferred from the monitored signal strength, for example. The emanating signal may be a calibration signal, for example.

The sensor node 100 illustrated in FIG. 1 comprises a sensor 110. The sensor 110 receives the event signal 102 and according to various examples, transforms the event signal 102 into a form (e.g., an electrical signal) that facilitates further processing by the sensor node 100. In various examples, the sensor 110 may be substantially any transducer that is capable of sensing the event signal 102 produced by the event source 104. In particular, the sensor 110 may be adapted to receive and transform various types of physical quantities associated with the event signal 102 including, but not limited to, vibrations and various related pressure waves (e.g., seismic wave, acoustic waves, etc.), electromagnetic field fluctuations and waves, a presence or absence of various atomic or molecular species (e.g., a molecular sensor), and physical quantities resulting from various nuclear processes (e.g., ionizing radiation).

In some examples, the sensor 110 transforms the received event signal 102 into an electronic signal (e.g., a voltage, current, etc.) that corresponds to or is related to the received event signal 102. For example, a photonic sensor 110 (e.g., a photodiode) may transform the received event signal 102 comprising photons into a corresponding electrical signal at an output of the photonic sensor 110. In other examples, transformation of the received event signal 102 by the sensor 110 results in a change in a parameter or characteristic of the sensor 110. The parameter or characteristic change is related to or corresponds with the received event signal 102. For example, a capacitive sensor may provide a change in capacitance that is proportional to an amplitude of the received event signal 102.

Examples of transducers that sense an event signal 102 comprising a vibration include, but are not limited to, an accelerometer (e.g., a piezoelectric accelerometer, a microelectromechanical system (MEMS) accelerometer), a velocity sensor, a geophone and a seismometer. For example, the event signal 102 may be a vibration associated with a seismic event induced by a seismic event source 104 (e.g., a vibroseis vehicle). The sensor 110 may be an accelerometer that senses the vibration by being in contact with the ground through which the vibrations propagate from the seismic event produced by the seismic source 104, for example.

Other example transducers that may sense the vibration-type event signal 102 indirectly include, but are not limited to, various sensors that measure strain or pressure waves associated with the vibration. Examples of these sorts of sensors include, but are not limited to, strain-based piezoelectric sensors, microphone-type sensors, capacitor-based microphone-type sensor and various sensors based on piezo-resistivity. The sensor 110 as a strain sensor 110 attached to a structure (e.g., a bridge) and the event source 104 may used to vibrate the structure, for example. The vibrations, in turn, induce deformation of the structure that may be sensed by the strain sensor 110, for example. A known relationship between the vibration-induced deformation and the original vibrations produced by the event source 104 provides a means for indirectly measuring the original vibration 110, for example.

Other examples of the sensor 110 may sense an electromagnetic event signal 102 from an electromagnetic event source 104. For example, the electromagnetic event source 104 may be an optical source (e.g., a laser, a light emitting diode, etc.) and the electromagnetic event signal 102 may be an optical signal. The aforementioned photonic sensor 110 may be used to detect the optical event signal 102, for example. A sensor 110 that receives and detects the optical signal may be referred to as a photonic sensor 110. In another example, the electromagnetic event signal 102 is a radio frequency (RF) signal or microwave signal and the event source 104 is one or both of an RF transmitter and microwave transmitter. An antenna is an example of a sensor 110 that is adapted to receive one or both of RF event signals 102 and microwave event signals 102.

In yet other examples, the sensor 110 may be a sensor that senses another physical quantity emanating as the event signal 102 from the event source 104. For example, the sensor 110 may be a pressure sensor where the event source 104 produces a pressure wave as the event signal 102. An acoustic sensor (e.g., a microphone) is an example of a sensor 110 adapted to receive pressure waves in the form of sound waves from an audio source serving as the event source 104, for example. In yet other examples, the physical quantity emanating from the event source 104 may comprise a particle (e.g., a molecule, an atom, an alpha particle, a beta particle, etc.), for example. For example, the sensor 110 may be molecular sensor or a radiation sensor (e.g., a Geiger counter).

In particular, the sensor 110 may be a capacitive sensor, in some examples. A capacitive sensor is defined herein as a sensor that either directly transforms the event signal 102 into a change or variation in a capacitance or transforms a physical quantity associated with the event signal 102 into the capacitance variation. An output of the capacitive sensor 110 may be the variation of the capacitance, for example. In some examples, the capacitive sensor is an accelerometer. For example, the capacitive sensor may be a MEMS accelerometer. In a MEMS accelerometer, a proof mass is suspended in a frame that has an associated capacitance. A motion of the proof mass induces a variation in the associated capacitance that is proportional to the motion. The motion may be due to a force causing an acceleration of the frame relative to the proof mass, for example.

As illustrated, the sensor node 100 further comprises an interface module 120. The interface module 120 is configured to determine a response of the sensor 110 to the event signal 102. According to some examples, the interface module 120 has an adjustable MDS (i.e., minimum discernable or minimum detectable signal) level. Further, the interface module 120 has a power consumption that is a function of the adjustable MDS level. In some examples, the adjustable MDS level of the interface module 120 is set based on the location of the sensor node relative to the location of event source 104 to optimize the power consumption. For example, the adjustable MDS level may be set to reduce, or in some examples, substantially minimize, the power consumption of the interface module 120 based on the relative location of the sensor node 100 and the event source 104. In some examples, the interface module 120 may be implemented as an applications specific integrated circuit (ASIC).

In some examples, the adjustable MDS level is determined by a noise floor of either the interface module 120 or a combination of the interface module 120 and the sensor 110. In particular, to be detected, an event signal 102 generally must produce a response or have a signal level that is greater than or equal to the noise floor at an input to the sensor 110 for the event signal 102. For example, a signal-to-noise ratio (SNR) of the signal level may be at least zero decibels (dB) in a specific bandwidth to be reliably detected in the presence of noise. In this example, the MDS level is a signal level that produces an SNR of 0 dB. In other examples, a target SNR of about 1 dB or even more may be used to reliably detect and process the event signal 102. In these examples, the MDS level is the event signal level that produces the target SNR for reliable detection and processing. Hence, the SNR and by extension, the noise floor that defines the SNR, substantially determines or defines the MDS level of the sensor node 100, according to some examples. In other examples, the adjustable MDS level may be determined by a parameter other than the noise floor. For example, the sensor may have a minimum activation level that is substantially independent of the noise floor.

In some examples, the power consumption by the interface module 120 may be an inverse function of the noise floor. In particular, adjustments made to interface module 120 that affect the power consumption may also affect the noise floor. Furthermore, adjustments that reduce power consumption may result in an increase in the noise floor. Hence, the MDS level may be adjustable by adjusting the noise floor which, in turn, produces a change in the power consumption of the interface module 120, in some examples. Moreover, there may be an inverse relationship between the change in noise floor, or equivalently an adjustment of the MDS level, and a concomitant change in power consumption, according to some examples. For example, the relationship between noise floor and power consumption in many capacitive sensor systems is substantially an inverse function.

FIG. 2 illustrates a schematic diagram of a portion of a sensor node 200, according to an example of the principles described herein. In particular, FIG. 2 illustrates a capacitive sensor 210 (e.g., a capacitive accelerometer) and an interface module 220. The interface module 220 is configured to determine a response of the sensor 210 in terms of a change in capacitance, for example. According to some examples, the interface module 220 converts the change in capacitance of the capacitive sensor 210 produced by an event signal into a detected signal (e.g., a voltage or current signal) that is substantially proportional to the event signal. For example, the interface module 220 employs synchronous detection to produce the detected signal. The interface module 220 may further digitize the detected signal, in some examples. According to some examples, the sensor node 200, the sensor 210 and the interface module 220 are substantially similar to respective ones of the sensor node 100, the sensor 110 and the interface module 220 described with respect to FIG. 1.

As illustrated in FIG. 2, the interface module 220 comprises a carrier source or modulation driver 222. The modulation driver 222 produces a carrier signal that is applied to the capacitive sensor 210. According to some examples, the carrier signal comprises a periodic voltage waveform that is characterized by a carrier or drive voltage and a carrier frequency. The drive voltage is related to a voltage swing of the periodic voltage waveform, according to various examples. For example, the drive voltage may be a peak-to-peak voltage swing of the periodic voltage waveform. In another example, the drive voltage may be either a peak voltage, a root-mean-square (RMS) voltage or another voltage of the periodic voltage waveform. The carrier frequency is a fundamental frequency component of the carrier signal, according to some examples.

The carrier signal is applied to the capacitive sensor 210, as illustrated in FIG. 2, to facilitate dynamic sensing of the event signal. According to some examples, the periodic voltage waveform of the carrier signal imparts a periodic perturbation of a capacitive element of the capacitive sensor 210. For example, in a capacitive sensor 210 such as an accelerometer, the capacitive element may comprise a proof mass mechanically connected to a moveable metal plate or similar conductive section of a capacitor. The periodic perturbation of the capacitive element by the carrier signal produces a periodic change in capacitance and a periodic output signal of the capacitive sensor 210.

The event signal may also produce a perturbation of the capacitive element of the capacitive sensor 210. For example, movement of the moveable metal plate under the influence of the proof mass in response to the event signal may result in a change in capacitance of the capacitive sensor 210 that differs or varies from the periodic change in capacitance produced by the carrier signal. In particular, the event signal perturbation substantially modulates the periodic output signal of the capacitive sensor 210 to yield a modulated periodic output signal, according to some examples.

One or both of the drive voltage and the carrier frequency of the carrier signal produced by the modulation driver 222 are adjustable, according to some examples of the principles described herein. For example, the drive voltage of the carrier signal may be adjustable between about 1 volt (V) and about 100 V. In another example, the drive voltage may be adjustable between about 1 V and about 12 V. In another example, the drive voltage may be adjustable between about 2.5 V and about 4.5 V. The carrier frequency may be adjustable in a range of between about 1 kilohertz (kHz) and about 10 megahertz (MHz), for example. In some examples, the carrier frequency may be adjustable between about 5 kHz and about 50 kHz. In other examples, the carrier frequency may be adjustable between about 10 kHz and about 50 kHz. In yet other examples, the carrier frequency may be adjustable between about 100 kHz and about 300 kHz. Depending on a tradeoff between noise floor and power consumption, the modulation frequency may respectively be a larger or a smaller multiple of a detection bandwidth, according to some examples.

In some examples, one or both of the drive voltage and the carrier frequency may be adjusted to adjust the power consumption and the MDS level of the interface module 220, for example. In particular, power consumption may be proportional while MDS level may be inversely proportional to one or both of the drive voltage and the carrier frequency. Hence, an adjustment to increase one or both of the drive voltage and the carrier frequency may result in an increase in power consumption by the interface module 220, for example. Concomitant with the higher consumption, one or both of the increased drive voltage and the increased carrier frequency may further provide a lower noise floor, according to some examples. Conversely, decreasing one or both of the drive voltage and the carrier frequency may yield a decrease in the power consumption by the interface module 220 while higher noise floor, according to some examples. Since a level of a minimum detectable signal (MDS) is related to the noise floor, adjusting the lower noise floor by adjusting one or both of the drive voltage and the carrier frequency, in turn, facilitates providing an adjustable MDS level of the interface module 220, according to some examples. Moreover, the adjustable MDS level provided by the adjustable noise floor is related to (e.g., proportional to) the power consumption when implemented by adjusting one or both of the drive voltage and the carrier frequency, according to some examples.

The interface module 220 further comprises a sense amplifier 224. The sense amplifier 224 may comprise a charge sense amplifier, for example. The sense amplifier 224 is configured to sense and in some examples, amplify the output signal of the capacitive sensor 210. Sensing may comprise transforming the capacitive sensor 210 output signal into another form (e.g., into a voltage or a current). For example, the sense amplifier 224, as the charge sense amplifier, may convert the output signal of the capacitive sensor 210 (e.g., in the form of a variation in a charge) into a signal comprising a voltage variation. The varying voltage of the converted output signal includes characteristics of the modulated periodic output signal of the capacitive sensor 210, according to various examples.

According to some examples, the adjustable MDS level may be related to a bias level of the sense amplifier 224. For example, the bias level of the sense amplifier 224 may affect a noise floor of the sensor node 200. The noise floor may be affected by a change in a noise figure of the sense amplifier 224 that is functionally related to the bias level, for example. In some examples, there may be an inverse relationship between the bias level and the adjustable MDS level. In other words, increasing the bias level may yield a decrease in the adjustable MDS level, for example.

Moreover, the adjustable MDS level provided by the bias level is related to the power consumption, according to some examples. In particular, an increased bias level generally results in an increased (higher) power consumption by the sense amplifier, for example. As such, according to some examples, providing a higher adjustable MDS level by lowering the bias level may result in lowering the power consumption by the sense amplifier 224. Conversely, increasing the bias level may increase power consumption while simultaneously lowering or decreasing the adjustable MDS level, according to some examples.

The interface module 220 further comprises a detector 226. The detector 226 demodulates the converted output signal from the sense amplifier 224 to produce a base band signal. The base band signal comprises a characteristic (e.g., a voltage) that is proportional to the event signal. In some examples (e.g., as illustrated in FIG. 2), the detector 226 comprises a synchronous detector 226a and a low pass filter 226b. The synchronous detector 226a receives the converted output signal from the sense amplifier 224 as well as the carrier signal from the modulation driver 222. The synchronous detector 226a multiplies together the converted output signal and the carrier signal from the modulation driver 222 to form a product signal. The product signal then passes through and is filtered by the low pass filter 226b to remove high frequency components and produce the base band signal.

In some examples, the interface module 220 further comprises an analog-to-digital converter (ADC) 228. The ADC 228 receives and digitizes the base band signal. A digitizing resolution, or number of bits in a digitized output, of the ADC 228 may be selected to insure that a quantization noise is lower than a minimum noise floor, according to some examples. For example, the ADC 228 may be a 20-bit ADC that provides a quantization noise floor of about −122 dB.

Referring again to FIG. 1, in some examples the sensor node 100 further comprises a power supply 130. The power supply 130 may comprise a battery and power conditioning circuitry (e.g., a voltage converter and regulator). Power provided by the power supply 130 is routed (not illustrated) to various elements and modules of the sensor node 100. Power-consumption optimization may influence characteristics of the power supply 130 including, but not limited to, one or more of size, operation time (or time before depletion when deployed), and overall operational lifespan, for example.

In some examples, the sensor node 100 further comprises a location sensor 140. The location sensor 140 determines a location of the sensor node 100. In some examples, the location sensor 140 may determine an absolute location of the sensor node 100 in a coordinate system (e.g., a latitude, longitude and elevation). In other examples, the location sensor 140 provides a relative location such as, but not limited to, a distance to the event source 104 and a combination of a distance and a direction to the event source 104, for example. The determined location may be used in the location-based power consumption optimization, for example.

In some examples, the location sensor 140 comprises a global positioning system (GPS) module. In other examples, the location sensor 140 employs another means to determine location. For example, the location sensor 140 may use a laser interferometer to determine the location of the sensor node 100. In yet other examples, a radio frequency (RF) signal or a microwave frequency signal may be employed by the location sensor 140 to establish location. For example, radio direction and ranging (RADAR) may be employed by the location sensor 140 to establish the location of the sensor node 100. Time difference of arrival (TDOA), signal strength reduction, or similar radiometric approaches also may be employed by the location sensor 140, for example.

In some examples, the sensor node 100 further comprises a communication module 150. The communication module 150 provides communication between the sensor node 100 and one or more of other sensor nodes 100, the event source 104 and a central command and control unit of a sensor system (not illustrated). In some examples, the communication module 150 comprises a radio. For example, the radio may be employed to provide wireless communications. Wireless communications may include, but are not limited to, one or more of Bluetooth™ for relatively short range wireless networks, WiFi for short to medium range wireless networks, and for longer range wireless networks, one or more of satellite communications networks, point-to-point microwave and related microwave relay networks, and ultrahigh frequency (UHF), very high frequency (VHF), cellular networks (e.g., cell phone network), and other RF wide area networks, for example. Bluetooth™ is a U.S. Trademark registered to Bluetooth SIG of Kirkland, Wash. In another example, wireless communication of the communication module 150 may be provided by an optical communications channel (e.g., a point-to-point laser system, an Infrared Data Association (IrDA) link, etc.). In some examples, the communication module 150 provides wired communications through a wired channel such as, but not limited to, Ethernet, digital subscriber line (DSL) over a public switched telephone network (PSTN), and various coaxial cable based networks (e.g., cable Internet). The communication module 150 also may employ one or both of proprietary wired and proprietary wireless networking, and various combinations of any of the above wireless communications and wired communications.

In some examples, the sensor node 100 further comprises a controller 160. The controller 160 may comprise a central processing unit (CPU) and memory. For example, the CPU may be a microprocessor or a microcontroller. The microprocessor may execute a program stored in memory to control operations of various modules and other components of the sensor node 100, for example. The executed program in conjunction with the memory may include means (e.g., algorithms, lookup tables, etc.) for determining how to adjust the MDS level based on location information provided by the location sensor 140, for example. The microprocessor may also be responsible for one or more of storing the location information in the memory for subsequent use, tracking a relative location of the event source 104, and handling communications with the central command and control unit via the communication module 150, for example.

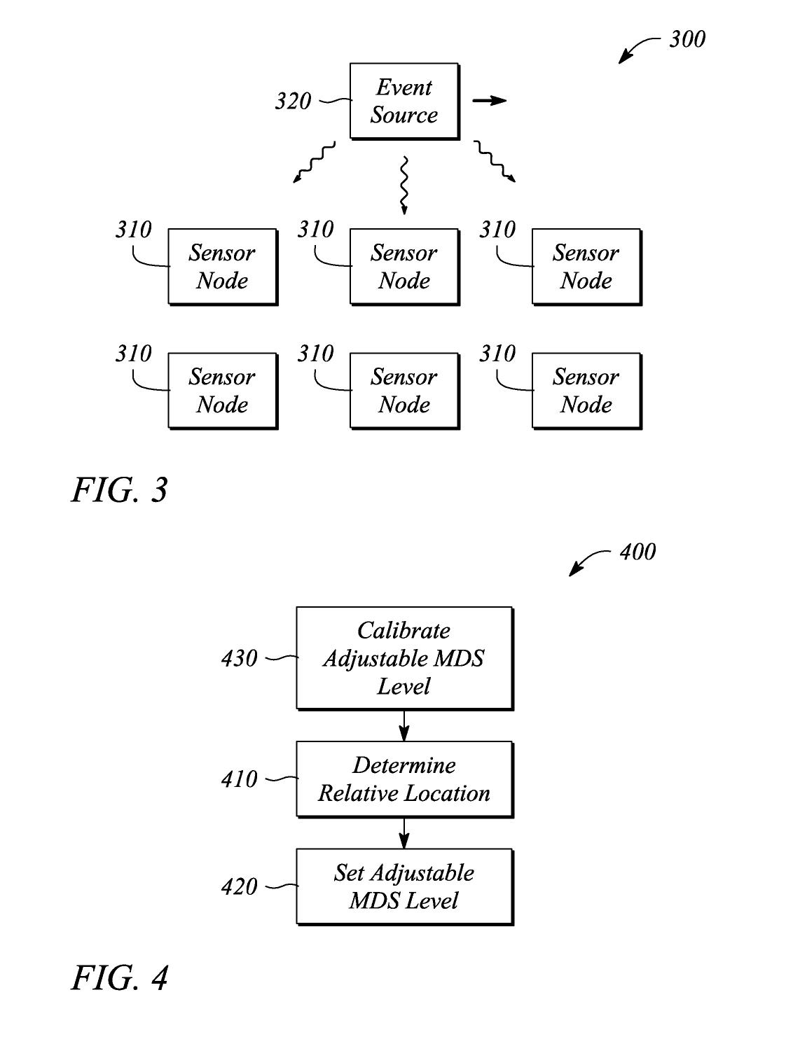

FIG. 3 illustrates a block diagram of a sensor system 300, according to an example of the principles described herein. As illustrated, the sensor system 300 comprises a plurality of sensor nodes 310 to sense a physical quantity from an event source 320. Each sensor node 310 has an adjustable MDS level associated with the physical quantity. Further, each sensor node 310 has a power consumption that is a function of the adjustable MDS level.

In some examples, the sensor node 310 is substantially similar to the sensor node 100 and the physical quantity is substantially similar to the event signal 102, described above. For example, according to some examples the sensor node 310 may comprise a capacitive sensor. In particular, the sensor node 310 may comprise a MEMS accelerometer, according to some examples. The MEMS accelerometer may be realized as a capacitive sensor and may be used to sense a physical quantity (e.g., motion, acceleration, etc.) associated with a seismic vibration, for example. In other examples, the sensor node 310 and associated physical quantity may represent another combination of sensor type and physical quantity sensed including, but not limited to, those that have been explicitly described above with respect to the sensor node 100.

The sensor system 300 illustrated in FIG. 3 further comprises an event source 320. The event source 320 is configured to produce the physical quantity. The event source 320 may be substantially similar to the event source 104 described above with respect to the sensor node 100, according to some examples. In particular, the event source 320 may be a seismic event source such as, but not limited to, a vibroseis source (e.g., a vehicle mounted vibroseis source), for example.

According to various examples, the adjustable MDS level of a sensor node 310 of the plurality is set according to a location of the sensor node 310 relative to a location of the event source 320. The adjustable MDS level may be set according to the relative locations to optimize power consumption of the sensor system 300, for example. For example, the adjustable MDS level may be set as described above with respect to the relative locations of the sensor node 100 and the event source 104. In particular, the adjustable MDS level of the sensor nodes 310 that are relatively close to the event source 320 may be set higher (e.g., by setting a higher noise floor) than the sensor nodes 310 that are relatively farther away from the event source 320, which may have adjustable MDS levels that are set relatively lower, for example. Setting the adjustable MDS level lower may insure detection of the physical quantity at the relatively greater distance from the event source 320, for example.

Power consumption of the sensor system 300 is reduced, or may be optimized (e.g., minimized), when power consumption of the individual sensor nodes 310 is inversely proportional to or is an inverse function of the adjustable MDS level, for example. In other words, sensor nodes 310 that have the adjustable MDS level set higher may consume less power than sensor nodes 310 with a lower-set adjustable MDS level. However, since the adjustable MDS level is set based on relative location (e.g., relative distance to the event source 320), all of the sensor nodes 310 of the sensor system 300 still may be capable of detecting and processing the physical quantity produced by the event source 320.

According to some examples, the event source 320 may be mobile. A mobile event source 320 is illustrated in FIG. 3 by a heavy arrow. In other examples, the event source 320 may have a fixed position and one or more of the sensor nodes 310 may be mobile. In yet other examples, the positions of the event source 320 as well as each of the sensor nodes 310 is fixed. When one or both of the event source 320 and the sensor node(s) 310 are mobile, the adjustable MDS level of the sensor node(s) 310 may be set dynamically.

In some examples, such as when the sensor node 310 comprises a capacitive sensor that employs dynamic sensing, the adjustable MDS level may be set by adjusting one or more of a carrier frequency applied to the capacitive sensor, a drive voltage applied to the capacitive sensor, and a bias of a sense amplifier connected to sense a change in capacitance of the capacitive sensor induced by the physical quantity. In some examples, the carrier frequency is substantially similar to the carrier frequency described above with respect to the modulation driver 222 of the interface module 220 with respect to the sensor node 200. In some examples, the drive voltage is substantially similar to the drive voltage described above with respect to the modulation driver 222 of the interface module 220. In some examples, the bias of a sense amplifier is substantially similar to the bias level of the sense amplifier 224 of the interface module 220 described above.

FIG. 4 illustrates a flow chart of a method 400 of location-based power consumption optimization of a sensor system, according to an example of the principles described herein. As illustrated, the method 400 of location-based power consumption optimization comprises determining 410 a relative location of a sensor node of the sensor system with respect to a location of an event source. The sensor node may be substantially similar to the sensor node 100, 200, 310 described above, according to various examples. For example, the sensor node may comprise a MEMS accelerometer configured to sense a seismic event.

The method 400 of location-based power consumption optimization further comprises setting 420 an adjustable MDS level of the sensor node according to the determined relative location. In some examples, the adjustable MDS level may be set as a function of radial distance from the event source. In other examples, an absolute location of one or both of the sensor node and the event source is used to set the adjustable MDS level. Setting 420 the adjustable MDS level may substantially optimize power consumption of the sensor node according to the determined relative location, in some examples. The adjustable MDS level may be substantially similar to the adjustable MDS level of the sensor node 100, 200, 310 described above, according to some examples.

For example, when the sensor node comprises a MEMS accelerometer or similar capacitive sensor, setting 420 the adjustable MDS level may comprise changing one or more of a carrier frequency applied to the MEMS accelerometer, a drive voltage applied to the MEMS accelerometer, and a bias of a sense amplifier connected to sense an output of the MEMS accelerometer or similar capacitive sensor. In some examples, the carrier frequency is substantially similar to the carrier frequency described above with respect to the modulation driver 222 of the interface module 220 with respect to the sensor node 200. In some examples, the drive voltage is substantially similar to the drive voltage described above with respect to the modulation driver 222 of the interface module 220. In some examples, the bias of a sense amplifier is substantially similar to the bias level of the sense amplifier 224 of the interface module 220 described above.

In some examples, the sensor node may accomplish one or both of determining 410 a relative location and setting 420 the adjustable MDS level in situ. For example, determining 410 the relative location and setting 420 the adjustable MDS level may be performed after deployment and activation of the sensor nodes as part of a sensor system, such as sensor system 300, for example. Changing one or more of the carrier frequency, the drive voltage and the bias to accomplish setting 420 the adjustable MDS level may be under control of a controller (e.g., a microprocessor) of the sensor node, e.g., controller 160 of the sensor node 100, according to some examples. Moreover, determining 410 the relative location and setting 420 the adjustable MDS level may be performed dynamically during operation of the sensor system, for example. For example, dynamically determining 410 and setting 420 may be used when one or both of the sensor node(s) and the event source are mobile. In other examples, determining 410 the relative location and setting 420 the adjustable MDS level are performed prior to or during sensor node deployment. For example, determining 410 the relative location and setting 420 the adjustable MDS level may be performed manually, as part of setting up a sensor system in the field, for example.

The method 400 of location-based power consumption optimization further comprises calibrating 430 the adjustable MDS level of the sensor node as a function of radial distance between the sensor node and the event source. Calibration 430 may be performed prior to determining 310 the relative location and setting 420 the adjustable MDS level, for example. The calibration 430 may be provided by a calibration signal produced by the event source prior to production of an event signal that is to be detected by the sensor node, according to some examples. For example, the calibration signal may comprise a pulse of a known amplitude or level. In addition, a level of the calibration signal as received by the sensor node may be used to estimate or measure the radial distance, for example.

Thus, there have been described examples of a sensor node, a sensor system, and a method that provide and employ location-based power consumption optimization in which an adjustable MDS level of the interface module is set based on a location of the sensor node relative to a location of a source of the event signal. It should be understood that the above-described examples are merely illustrative of some of the many specific examples that represent the principles described herein. Clearly, those skilled in the art can readily devise numerous other arrangements without departing from the scope as defined by the following claims.

What is claimed is:

1. A sensor node comprising:
a sensor to respond to an event signal; and
an interface module to determine the sensor response to the event signal, the interface module having an adjustable minimum detectable signal (MDS) level and a power consumption that is a function of the adjustable MDS level,
wherein the adjustable MDS level of the interface module is set based on a location of the sensor node relative to a location of a source of the event signal to optimize the power consumption.

2. The sensor node of claim 1, wherein the adjustable MDS level is determined by a noise floor of the interface module and the sensor, the power consumption being an inverse function of the noise floor.

3. The sensor node of claim 1, wherein the source of the event signal is mobile so that the relative location of the sensor node to the source location changes, the adjustable MDS level of the interface module being dynamically set according to the changing relative location.

4. The sensor node of claim 1, wherein the sensor is a capacitive sensor, the sensor response being a change in a capacitance of the capacitive sensor in response to the event signal.

5. The sensor node of claim 4, wherein the capacitive sensor is a microelectromechanical system (MEMS) accelerometer, the event signal source being a seismic vibration, and wherein the adjustable MDS level is set based on a radial distance from the event signal source to the sensor node.

6. The sensor node of claim 4, wherein the adjustable MDS level is set based on the relative location by adjusting one or both of a carrier frequency and a drive voltage applied to the sensor.

7. The sensor node of claim 1, wherein the interface module comprises a sense amplifier, the adjustable MDS level being set based on the relative location by adjusting a bias of the sense amplifier.

8. A sensor system comprising:
a plurality of sensor nodes to sense a physical quantity, a sensor node of the plurality having an adjustable minimum detectable signal (MDS) level associated with the physical quantity and a power consumption that is a function of the adjustable MDS level; and
an event source to produce the physical quantity,
wherein the adjustable MDS level of the sensor node is set according to a location of the sensor node relative to a location of the event source to optimize power consumption of the sensor system.

9. The sensor system of claim 8, wherein the event source is a seismic vibration source, the physical quantity being a seismic vibration, and wherein the sensor node comprises a microelectromechanical systems (MEMS) accelerometer as a sensor.

10. The sensor system of claim 8, wherein the sensor node comprises a capacitive sensor, the adjustable MDS level being set according to the location of the sensor node relative to the location of the event source by adjusting one or more of a carrier frequency applied to the capacitive sensor, a drive voltage applied to the capacitive sensor and a bias of a sense amplifier connected to sense a change in capacitance of the capacitive sensor induced by the physical quantity.

11. The sensor system of claim 8, wherein the event source is mobile, the adjustable MDS level of each sensor node of the plurality being dynamically set according to the location of the respective sensor node relative to a changing location of the event source.

12. A method of location-based power consumption optimization of a sensor system, the method comprising:
determining a relative location of a sensor node of the sensor system with respect to a location of an event source; and
setting an adjustable minimum detectable signal (MDS) level of the sensor node according to the determined relative location,
wherein setting the adjustable MDS level optimizes a power consumption of the sensor node according to the determined relative location.

13. The method of claim 12, wherein the sensor node comprises a microelectromechanical system (MEMS) accelerometer, the event source being a seismic source, and wherein the adjustable MDS level is set as a function of radial distance from the event source.

14. The method of claim 13, wherein setting the adjustable MDS level according to the determined relative location comprises changing one or more of a carrier frequency applied to the MEMS accelerometer, a drive voltage applied to the MEMS accelerometer, and a bias of a sense amplifier connected to sense an output of the MEMS accelerometer.

15. The method of claim 12, further comprising calibrating the adjustable MDS level of the sensor node as a function of radial distance between the sensor node and the event source, the adjustable MDS level calibration comprising a calibration signal produced by the event source prior to production of an event signal from the event source that is to be detected by the sensor node.
